(19) United States
(12) Patent Application Publication
(10) Pub. No.: US 2026/0310620 A1
(43) Pub. Date: Oct. 8, 2026

(54) INTEGRATED CIRCUIT WITH ANALOG IN-MEMORY COMPUTE

(71) Applicant: OPTOML Pte Limited, Singapore (SG)

(72) Inventor: Saravana Maruthamuthu, Chennai (IN)

(21) Appl. No.: 19/573,638

(22) Filed: Mar. 20, 2026

(30) Foreign Application Priority Data
Mar. 21, 2025 (IN) 2025511026042

(51) Int. Cl. G06F 13/36

(52) U.S. Cl. CPC G06F 13/36; G06F 2213/40

(57) ABSTRACT

An integrated circuit comprising a plurality of cluster chiplets vertically stacked, each of the cluster chiplets comprising a plurality of tiles laterally arranged, each of the tiles comprising at least one processor core coupled to a cache, an analog in-memory compute (AIMC) device coupled to the at least one processor core, a digital access subsystem coupled to the AIMC device, and a cluster bus coupled to the digital access subsystem, and a system bus coupled to the cluster bus of each of the plurality of tiles, and at least one cache chiplet vertically stacked with the plurality of cluster chiplets, wherein the at least one cache chiplet is arranged between a pair of adjacent cluster chiplets from the plurality of cluster chiplets.

### RELATED APPLICATION

The present application claims priority to Indian Patent Application No. 202511026042, filed Mar. 21, 2026, the entire contents of which are hereby incorporated by this reference

### FIELD OF INVENTION

The invention generally relates to processors, and more particularly, to an integrated circuit with analog in-memory compute.

### BACKGROUND

In the field of Artificial Intelligence (AI), deep learning and neural network workloads require significant computational resources to process large datasets and execute complex algorithms. There is a growing demand for high-performance processors and processor systems across a wide range of applications. These applications demand high computational capacity to perform complex tasks with precision and speed. System-on-Chip (SoC) designs provide a solution to address the performance and efficiency challenges. SoC designs integrate multiple types of processing units on a single chip, combining various components such as AI accelerators, Central Processing Unit (CPU) cores, Graphics Processing Unit (GPU) cores, memory, and communication interfaces. Placing multiple dies within a single package can reduce the latency of communication between the separate dies for increased performance. These components are optimized to deliver high performance and energy efficiency for specific applications, particularly in environments where space, power, and thermal constraints are important. By consolidating multiple components into one chip, SoCs enable more compact and integrated solutions.

Among the components, AI accelerators are specialized processors designed to accelerate the computation processes required for AI tasks, particularly those involving large-scale data processing, deep learning, machine learning, and other AI workloads. These accelerators are optimized for the types of mathematical operations commonly used in AI models, such as matrix multiplications, convolutions, and other linear algebra operations, allowing them to perform these tasks much faster and more efficiently than general-purpose processors like CPUs.

FIG. 1 illustrates an example of an integrated circuit 100 corresponding to the AI accelerator with current architecture as known in the art. The integrated circuit 100 includes a system-on-chip 102 comprising a plurality of clusters 104 such as cluster 104-1 through cluster 104-N (hereinafter referred to as the ‘cluster 104’). Each cluster 104 comprises a processor core 106 (referenced as 106-1 to 106-N) communicatively coupled to a cache 108 (referenced as 108-1 to 108-N) and a digital tensor compute accelerator (DTCA) core 110 (referenced as 110-1 to 110-N) communicatively coupled with a scratchpad memory (SPM) 112 (referenced as 112-1 to 112-N). Example of the processor core 106 include, but not limited to, CPU core. The integration of the cache 108 enables storing frequently accessed data near the processing core. Examples of DTCA core include, but not limited to, application-specific integrated circuits (ASICs) optimized for tensor computations, tensor processing cores integrated in graphics processing units (GPUs), and other specialized hardware accelerators for matrix and tensor operations in AI workloads. Examples of the SPM 112 include, but not limited to, Digital In-Memory Computing (DIMC) memory, Static Random-Access Memory (SRAM). The DTCA core 110 is coupled with the SPM 112 enabling high-speed temporary storage of computation data. Typically, in the current architecture, the DTCA cores 110 are optimized for matrix operations prevalent in AI algorithms and the processor cores 106 are dedicated control processors for task scheduling, synchronization, and execution control.

The processor core 106 and the DTCA core 110 are communicatively coupled to each other via an interface (interchangeably referred to as ‘PC-DTCA-IF’) 114 (referenced as 114-1 to 114-N), The interface 114 enables efficient data transfer between the processor core 106 and the DTCA core 110. The processor core 106 and the DTCA core 110 are further communicatively coupled to a cluster bus 116 (referenced as 116-1 to 116-N) via the cache 108 and the SPM 112. The cluster bus 116 facilitates internal communication between the processor core 106, the DTCA core 110, the cache 108 and the SPM 112 within the cluster 104.

Further, the plurality of clusters 104 are communicatively coupled to each other via a system bus 118. Examples of the system bus 118 include, but not limited to, high-speed digital buses and network-on-chip (NoC) architectures and can be selected based on optimizing various parameters such as latency, throughput, AI performance, traffic, congestion. The system bus 118 is further communicatively coupled with one or more external memory interface (EXT-MEM-IF) 120 and one or more external high-speed input-out interface (EXT-IO-IF) 122. Example of the external high-speed input-output interface includes, but not limited to, high-speed Serializer/Deserializer (SERDES). The system bus 118 can be communicatively coupled with one or more external memory (EXT-MEM) 124 via the external memory interface 120 to provide additional storage capacity. Example of the external memory 124 includes, but not limited to, Double Data Rate Random Access Memory (DDR-RAM). The system bus 118 can be further communicatively coupled with one or more external host processor 126 via the external high-speed input-out interface 122 to enable high speed data transfer between the integrated circuit 100 and the external host processor 126.

However, the current architecture of the AI accelerator provides significant challenges in achieving optimal Power-Performance-Area (PPA) efficiency, i.e., minimizing power consumption, optimizing performance speed, and minimizing physical area or chip area usage. Typically, AI accelerators with the current architecture exhibit power efficiencies below 2 trillion of operations per second per watt (TOPS/W), limiting scalability to meet growing computational demands. One solution to increase scalability can be to increase the number of cluster 104 to enhance performance. However, this can lead to space constraints and complexities in overall integration and packaging of the integrated circuit 100 due to limited overall chip area. This reduces power efficiency and increases thermal challenges.

Further, the DTCA core 110 exhibits slower computation speed when performing computations that are highly parallel or involve large datasets. This results in inefficiencies in compute-intensive AI and machine learning workloads. Additionally, frequent high speed data transfers between the DTCA core 110 and the SPM 112 introduce latency (or delays in computation) and increase power consumption, and cause traffic congestion over time, thereby reducing overall computing efficiency. In addition, the use of DIMC as the SPM 112 consumes substantial chip area due to the requisite additional circuitry and routing to perform in-memory operations. This poses a challenge in maintaining compact and efficient designs, particularly for large-scale memory applications demanding both high-density storage and computational capabilities.

Therefore, there is a need for improved architecture for AI accelerators that address these challenges.

### SUMMARY

The example embodiments of the present disclosure will disclose an integrated circuit with analog in-memory compute.

According to an aspect of the embodiments, the integrated circuit comprising a plurality of cluster chiplets vertically stacked, each of the cluster chiplets comprising a plurality of tiles laterally arranged, each of the tiles comprising at least one processor core coupled to a cache, an analog in-memory compute (AIMC) device coupled to the at least one processor core, a digital access subsystem coupled to the AIMC device, and a cluster bus coupled to the digital access subsystem. and a system bus coupled to the cluster bus of each of the plurality of tiles, and at least one cache chiplet vertically stacked with the plurality of cluster chiplets, wherein the at least one cache chiplet is arranged between a pair of adjacent cluster chiplets from the plurality of cluster chiplets.

It is to be understood that the summary is not intended to identify key or essential features of embodiments of the present disclosure, nor is it intended to be used to limit the scope of the present disclosure. The object and advantages of the invention will be realized and attained by means of the elements and combinations particularly pointed out in the claims. Further, it is to be understood that both the foregoing summary and the following detailed description are exemplary and explanatory and are not restrictive of the invention.

### BRIEF DESCRIPTION OF DRAWINGS

The example embodiments will now be described with reference to the accompanying drawings, wherein:

FIG. 1 is a block diagram illustrating an example of integrated circuit as known in the art;

FIG. 2 is simplified block diagram illustrating an example of an integrated circuit according to various embodiments of the present disclosure;

FIG. 3 is a simplified block diagram illustrating another example of an integrated circuit according to one embodiment of the present disclosure;

FIG. 4 is a simplified block diagram illustrating another example of an integrated circuit according to one embodiment of the present disclosure;

FIG. 5 is a simplified block diagram illustrating another example of an integrated circuit according to one embodiment of the present disclosure;

FIG. 6 is a simplified block diagram illustrating another example of an integrated circuit according to one embodiment of the present disclosure; and

FIG. 7 is a simplified block diagram illustrating a tile of the integrated circuit according to various embodiments of the present disclosure.

Throughout the drawings, the same or similar reference numerals represent the same or similar element.

### DESCRIPTION OF EMBODIMENTS

Principle of the present disclosure will now be described with reference to some example embodiments. It is to be understood that these embodiments are described only for the purpose of illustration and help those skilled in the art to understand and implement the present disclosure, without suggesting any limitation as to the scope of the disclosure. The disclosure described herein can be implemented in various manners other than the ones described below. In the following description and claims, unless defined otherwise, all technical and scientific terms used herein have the same meaning as commonly understood by one of ordinary skills in the art to which this disclosure belongs. The disclosure described herein can be implemented generally in integrated circuits and artificial intelligence (AI) systems. More particularly, the present invention relates to structure of the integrated circuit for accelerating AI based computing workloads such as AI accelerators. In addition, it is also permissible if, as the used terms and the described technical contents in the present description, terms and technical contents described in specifications and contributions as known in the AI and semiconductor industry.

Hereinafter, embodiment of the integrated circuit with analog in-memory compute disclosed in the present invention will be described in detail with reference to the drawings. Note that the following embodiments do not limit the disclosed technique.

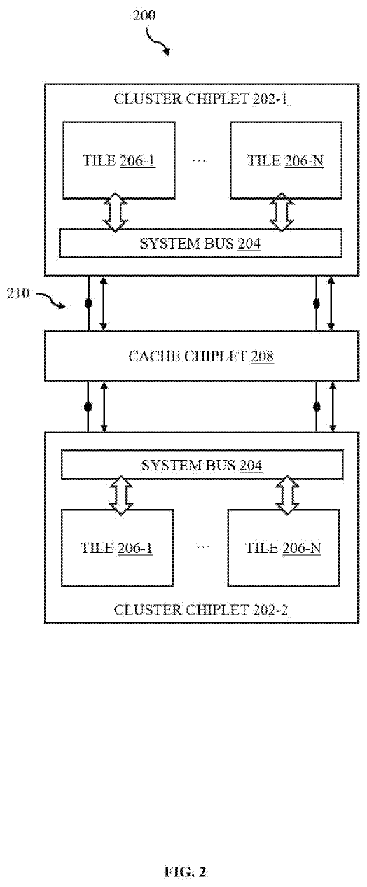

FIG. 2 is a simplified block diagram illustrating an example of integrated circuit 200 according to various embodiments of the present disclosure. Examples of the integrated circuit 200 include an artificial intelligence (AI) accelerator for accelerating AI based computing workloads. The integrated circuit 200 can be packaged in form of a system-on-chip (SOC). The integrated circuit 200 can be used for various applications within ultra-low-power edge devices and high-performance autonomous systems. Examples of application with such edge devices include, but are not limited to, smart home and consumer electronics, predictive maintenance in industrial Internet-of-Things (IoT), environmental and agriculture monitoring, and on-device AI copilots. Examples of applications within such autonomous systems include, but are not limited to, Autonomous mobile robots (AMRs), ADAS and in-cabin AI for vehicles, multi-sensor industrial automation, drones and smart surveillance systems, and edge LLM deployment in embedded platforms. The integrated circuit 200 may be initially trained offline (e.g., at the time of manufacture) and operational parameters such as clock rate, frequency, etc., may be set based on controlled inputs or learning data sets corresponding to the different workloads expected to be faced for the desired application.

In accordance with the various embodiments of the present invention, the integrated circuit 200 comprises a plurality of cluster chiplets 202 (hereinafter referred to as ‘cluster chiplet 202’ in singular and ‘cluster chiplets 202’ in plural) vertically stacked to form a three-dimensional (3D) arrangement. As used herein, the cluster chiplets are vertically stacked when the cluster chiplets are placed on top of each other in a column. Each of the cluster chiplets 202 comprises a system bus 204 and a plurality of tiles 206-1 . . . 206-N (hereinafter referred to as ‘tile 206’ in singular and ‘tiles 206’ in plural). The plurality of tiles 206 are laterally arranged within the cluster chiplet 202 and are vertically stacked with the system bus 204. As used herein, the tiles are laterally arranged when the tiles are placed adjacent to each other in a row. Each of the tiles 206 includes at least one processor core, a cache, an analog in-memory compute device, a digital access subsystem, a control interface, and a cluster bus (not shown in the figure). The plurality of tiles 206 within each cluster chiplet 202 is communicatively coupled with the system bus 204.

In accordance with the embodiments of the present invention, the system bus 204 communicatively couples to the cluster bus of each of the tiles 206 within each of the cluster chiplets 202 for optimized communication between the cluster chiplets 202. The system bus 204 supports high-speed, low-latency data transmission among cluster chiplets 202. The system bus 204 can be multidirectional and can include multiple data lines to handle parallel communication, enabling the simultaneous transfer of multiple data streams for greater throughput. The system bus 204 can be configured to optimize energy efficiency and performance within each of the cluster chiplets 202. In an example, the system bus 204 can be configured to dynamically adjust power usage based on the communication load between cluster chiplets 202, contributing to the overall energy efficiency of the integrated circuit 200.

In one embodiment, each of the cluster chiplets 202 configured to handle specific tasks independently based on the application of the integrated circuit 200. In such embodiment, the system bus 204 ensures seamless communication of data and control signals among the cluster chiplets 202 such that the integrated circuit 200 is operating in accordance with the application and the resource utilization and power consumption are optimized within the integrated circuit 200. In an example, the cluster chiplet 202-1 can be configured to process AI inference tasks and the cluster chiplet 202-2 can be configured to process pre-processing and/or post-processing tasks. In such example, the system bus 204 facilitates the transfer of relevant data and intermediate results between these cluster chiplets 202. The system bus 204 may also allow for the transfer of control signals for synchronization and workload distribution across the cluster chiplets 202, ensuring that tasks are executed in parallel or in sequence as needed. Additionally, in one embodiment, the system bus 204 can be configured to support hierarchical communication among multiple cluster chiplets 202. This leads to expanding or scaling the integrated circuit 200 by adding more cluster chiplets in 3D arrangement without significant degradation in performance.

Further, in accordance with various embodiments of the present disclosure, the integrated circuit 200 comprises at least one cache chiplet 208 vertically stacked with the plurality of cluster chiplets 202 to form the 3D arrangement. The at least one cache chiplet 208 (hereinafter interchangeably referred to as “cache chiplet” in singular and “cache chiplets” in plural for brevity) is arranged between a pair of adjacent cluster chiplets (hereinafter interchangeably referred to as “first pair of adjacent cluster chiplets”) from the plurality of cluster chiplets 202 in the 3D arrangement. In the 3D arrangement, the plurality of cluster chiplets 202 is disposed in a layered configuration in a column, with each cluster chiplet 202 stacked upon another to form a multi-layered 3D structure. The cache chiplet 208 is positioned as an intermediary layer between two of the cluster chiplets 202 adjacent to each other in the column in the multi-layered 3D structure such that the cache chiplet 208 is coupled to the system bus 204 of each of the adjacent cluster chiplets. In one embodiment, plurality of cache chiplets can be arranged to share a common cluster chiplet within the multi-layered 3D structure. In another embodiment, plurality of cache chiplets can be arranged such that a common cluster chiplet is not shared within the multi-layered 3D structure. The cache chiplet 208 and the pair of adjacent cluster chiplets 202 are interconnected using a plurality of through-silicon vias (TSVs) and micro-bumps 210 optimized to support high bandwidth with low interference from other components of the integrated circuit 200 susceptible to interference. In the figure, the bidirectional arrows indicate bidirectional communication. This vertical stacking of the cluster chiplets 202 with the cache chiplet 208 as intermediary layer provides high-speed and dedicated cache memory to each of the cluster chiplets 202 and components therein. This results in efficient storage and faster retrieval of frequently accessed data, reduced latency, and improving overall performance of the integrated circuit 200, thereby minimizing the need for slower memory access. Examples of the cache chiplet 208 include, but are not limited to, Dynamic Random Access Memory (DRAM), Synchronous Dynamic Random Access Memory (SDRAM), RAMBUS® Dynamic Random Access Memory (RDRAM®) or any memory module having a higher storage density per unit area than Static Random Access Memory (SRAM). In one embodiment, the cache chiplet 208 can be single memory accessible by the pair of adjacent cluster chiplets. In another embodiment, the cache chiplet 208 can be a shared cache chiplet with a plurality of cache banks accessible by the pair of adjacent cluster chiplets.

Further, in accordance with one embodiment of the present disclosure, the integrated circuit 200 further comprises at least one external memory (not shown in the figure) vertically stacked with the plurality of cluster chiplets 202 forming the 3D arrangement. The at least one external memory (hereinafter interchangeably referred to as “external memory” in singular and “external memories” in plural for brevity) is arranged between a pair of adjacent cluster chiplets (hereinafter interchangeably referred to as “second pair of adjacent cluster chiplets”) from the plurality of cluster chiplets 202 in the 3D arrangement. In one embodiment, the first pair of cluster chiplets and the second pair of cluster chiplets may share a common cluster chiplet. In another embodiment, the first pair of cluster chiplets and the second pair of cluster chiplets may be disjointed, i.e., do not share any common cluster chiplet. Examples of such external memory include, but are not limited to, DRAM and other external memory modules. In one example, the external memory can be a single DRAM. In another example, the external memory can include plurality of DRAMs stacked together. Each of the pair of adjacent cluster chiplets 202 includes a memory controller (not shown in the figure) coupled to the system bus 204 and the external memory. The memory controller manages data transfers between the cluster chiplet and the external memory, handling address translation, timing control, and data buffering to optimize memory bandwidth utilization. The external memory and the pair of adjacent cluster chiplets 202 are interconnected using a plurality of TSVs and micro-bumps 210 supporting high memory bandwidth such that the external memory is communicatively coupled with the system bus of each of the cluster chiplets. The vertical stacking of the external memory with the cluster chiplets and the cache chiplet allows scaling of memory capacity of the integrated circuit 200 suitable for memory-intensive applications.

Referring to FIG. 2, a simplified block diagram of the example integrated circuit 200 with two cluster chiplets 202-1 and 202-2 and one cache chiplet 208 is illustrated. The cache chiplet 208 is vertically stacked between the pair of adjacent cluster chiplets 202-1 and 202-2 in a column forming the 3D arrangement. The cache chiplet 208 and the pair of adjacent cluster chiplets 202-1 and 202-2 are interconnected using the plurality of TSVs and micro-bumps 210 such that the cache chiplet 208 is coupled to the system bus 204 of each of the cluster chiplets 202-1 and 202-2. The plurality of TSVs and micro-bumps 210 enable efficient, low latency data transfer and contribute to the overall performance and scalability of the integrated circuit 200.

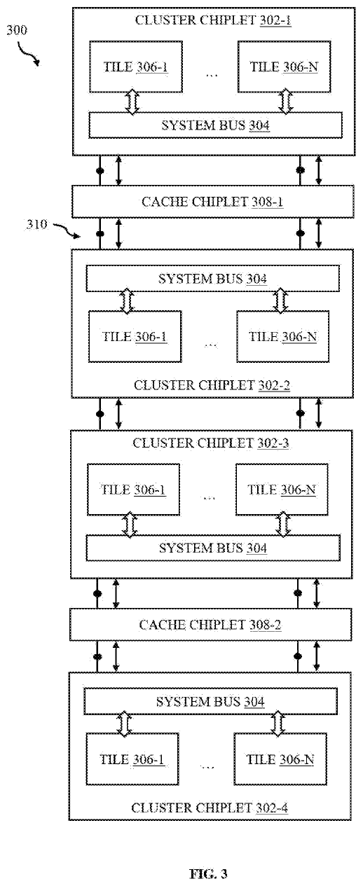

FIG. 3 is a simplified block diagram illustrating another example integrated circuit 300 in accordance with the embodiments of the present invention. The integrated circuit 300 comprises four cluster chiplets 302-1, 302-2, 302-3, and 302-4 vertically stacked forming the 3D arrangement. Each of the cluster chiplets 302-1, 302-2, 302-3, and 302-4 comprises a system bus 304 and a plurality of tiles 306-1 . . . 306-N communicatively coupled with the system bus 304. The plurality of tiles 306-1 . . . 306-N are laterally arranged and vertically stacked with the system bus 304. The four cluster chiplets 302 are vertically stacked with two cache chiplets 308-1 and 308-2. The cluster chiplets 302-1, 302-2, 302-3, and 302-4, the cache chiplets 308-1 and 308-2, the tiles 306-1 . . . 306-N, and the system bus 304 are same as that of the corresponding components in the integrated circuit 200 of FIG. 2.

Referring to FIG. 3, the cache chiplet 308-1 is vertically stacked between the pair of adjacent cluster chiplets 302-1 and 302-2 and the cache chiplet 308-2 is vertically stacked between the pair of adjacent cluster chiplets 302-3 and 302-4 forming the 3D arrangement. Thus, cache chiplets 308-1 and 308-2 do not share a common cluster chiplet within the multi-layered 3D structure. The cache chiplet 308-1 is coupled to the system bus 304 of each of the cluster chiplets 302-1 and 302-2 and the cache chiplet 308-2 is coupled to the system bus 304 of each of the cluster chiplets 302-3 and 302-4. The cache chiplets 308-1 and 308-2 and the cluster chiplets 302-1, 302-2, 302-3, and 302-4 are interconnected using a plurality of TSVs and micro-bumps 310. The cluster chiplets 302-2 and 302-3 are further interconnected using the plurality of TSVs and micro-bumps 310. This enables efficient, low latency data transfer and contributes to the overall performance and scalability of the integrated circuit 200.

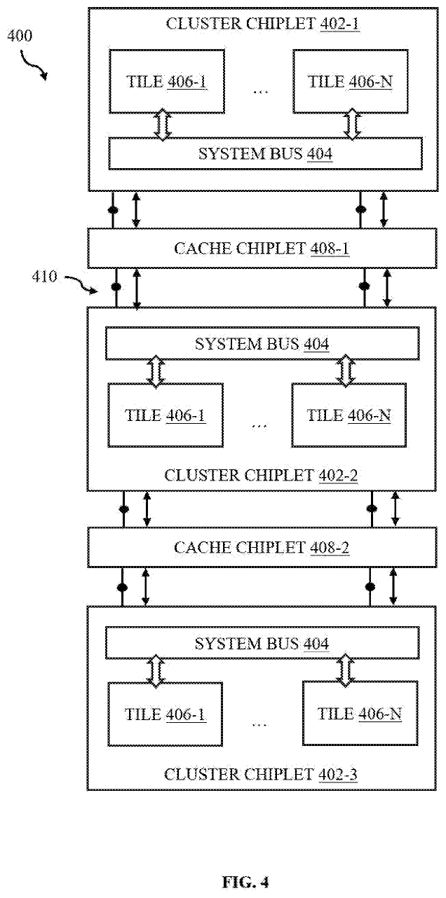

FIG. 4 is a simplified block diagram illustrating another example integrated circuit 400 in accordance with the embodiments of the present invention. The integrated circuit 400 comprises three cluster chiplets 402-1, 402-2, and 402-3 vertically stacked forming the 3D arrangement. Each of the cluster chiplets 402-1, 402-2, and 402-3 comprises a system bus 404 and a plurality of tiles 406-1 . . . 406-N communicatively coupled with the system bus 404. The plurality of tiles 406-1 . . . 406-N are laterally arranged and vertically stacked with the system bus 404. The three cluster chiplets 402-1, 402-2, and 402-3 are vertically stacked with two cache chiplets 408-1 and 408-2. The cluster chiplets 402-1, 402-2, and 402-3, the cache chiplets 408-1 and 408-2, the tiles 406-1 . . . 406-N, and the system bus 404 are same as that of the corresponding components in the integrated circuit 200 of FIG. 2.

Referring to FIG. 4, the cache chiplet 408-1 is vertically stacked between the pair of adjacent cluster chiplets 402-1 and 402-2 and the cache chiplet 408-2 is vertically stacked between the pair of adjacent cluster chiplets 402-2 and 402-3 forming the 3D arrangement. Thus, cache chiplets 408-1 and 408-2 share a common cluster chiplet 402-2 within the multi-layered 3D structure. The cache chiplet 408-1 is coupled to the system bus 404 of each of the cluster chiplets 402-1 and 402-2 and the cache chiplet 408-2 is coupled to the system bus 404 of each of the cluster chiplets 402-2 and 402-3. The cache chiplets 408-1 and 408-2 and the cluster chiplets 402-1, 402-2, and 402-3 are interconnected using a plurality of TSVs and micro-bumps 410. This enables efficient, low latency data transfer and contributes to the overall performance and scalability of the integrated circuit 200.

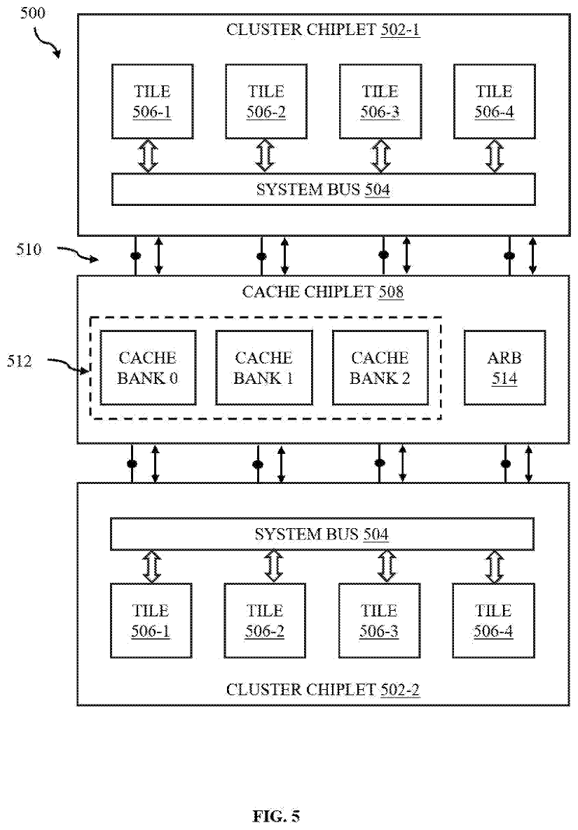

FIG. 5 is a simplified block diagram illustrating another example integrated circuit 500 in accordance with the embodiments of the present invention. The integrated circuit 500 comprises two cluster chiplets 502-1 and 502-2 vertically stacked forming the 3D arrangement. Each of the cluster chiplets 502-1 and 502-2 comprises a system bus 504 and a plurality of tiles 506-1 . . . 506-N communicatively coupled with the system bus 504. The plurality of tiles 506-1 . . . 506-N are laterally arranged and vertically stacked with the system bus 504. The two cluster chiplets 502-1 and 502-2 are vertically stacked with one shared cache chiplet 508. The cluster chiplets 502-1 and 502-2, the shared cache chiplet 508, the tiles 506-1 . . . 506-N, and the system bus 504 are same as that of the corresponding components in the integrated circuit 200 of FIG. 2.

Referring to FIG. 5, the shared cache chiplet 508 is vertically stacked between the pair of adjacent cluster chiplets 502-1 and 502-2 forming the 3D arrangement. The shared cache chiplet 508 is coupled to the system bus 504 of each of the cluster chiplets 502-1 and 502-2. The shared cache chiplet 508 and the cluster chiplets 502-1 and 502-2 are interconnected using a plurality of TSVs and micro-bumps 510. This enables efficient, low latency data transfer and contributes to the overall performance and scalability of the integrated circuit 200.

Further, the shared cache chiplet 508 comprises a plurality of cache banks 512 accessible by the cluster chiplets 502-1 and 502-2. The plurality of cache banks 512 divide a total cache capacity into parallel slices, with data interleaved across plurality of cache banks 512 (e.g., by low-order address bits) to enable simultaneous access from different cores and minimize conflicts. In one embodiment as illustrated in FIG. 5, the shared cache chiplet 508 includes three cache banks, cache bank 0, cache bank 1, and cache bank 2, and an arbitrator (ARB) 514. The arbitrator 514 is configured to manage access requests, prioritize the access requests (e.g., age-based), and schedule the access requests from the pair of adjacent cluster chiplets 502-1 and 502-2, and regulate bandwidth (e.g., per-bank limits) across the plurality of cache banks 512. The arbitrator 514 ensures orderly access to the plurality of cache banks 512 and prevents conflicts when multiple cluster chiplets 502 simultaneously request cache access.

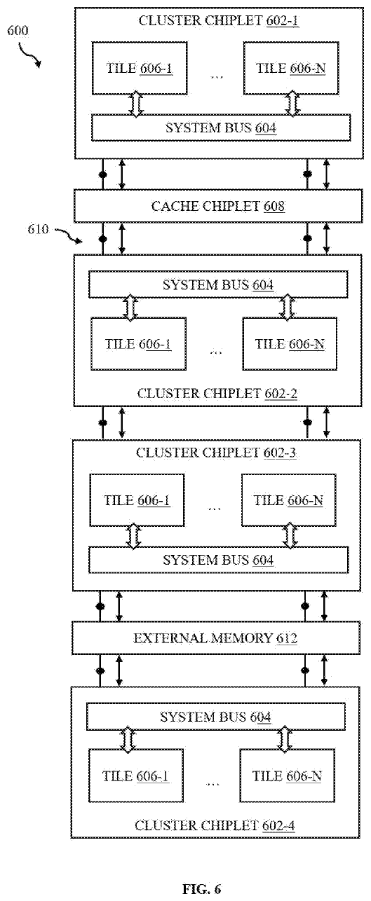

FIG. 6 is a simplified block diagram illustrating another example of integrated circuit 600 according to one embodiment of the present disclosure. The integrated circuit 600 comprises four cluster chiplets 602-1, 602-2, 602-3, and 602-4 vertically stacked forming a 3D arrangement. Each of the cluster chiplets 602-1, 602-2, 602-3, and 602-4 comprises a system bus 604 and a plurality of tiles 606-1 . . . 606-N communicatively coupled with the system bus 604. The plurality of tiles 606-1 . . . 606-N are laterally arranged and vertically stacked with the system bus 604. The first pair of adjacent cluster chiplets from the four cluster chiplets 602-1 and 602-2 are vertically stacked with a cache chiplet 608 in a 3D arrangement. The cluster chiplets 602-1, 602-2, 602-3, and 602-4, the cache chiplet 608, the tiles 606, and the system bus 604 are same as those of the corresponding components in the integrated circuit 200. The cache chiplet 608 is interconnected with the cluster chiplets 602-1 and 602-2 using a plurality of TSVs and micro-bumps 610.

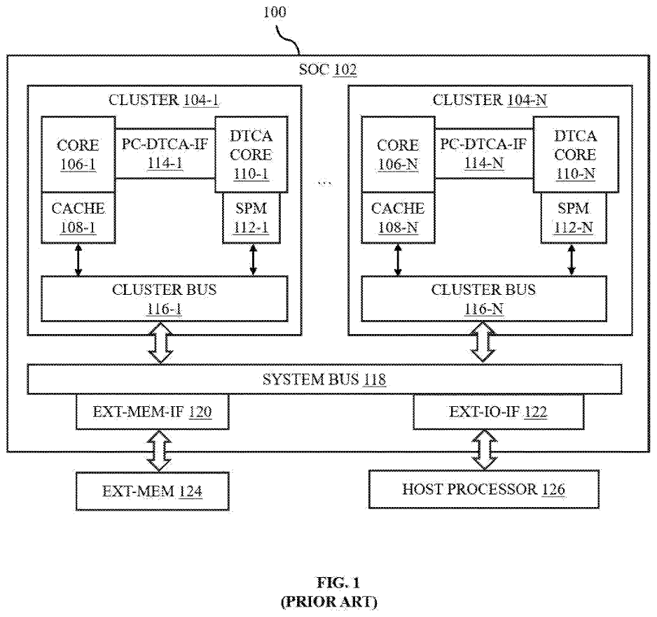

Further, the second pair of adjacent cluster chiplets from the four cluster chiplets 602-3 and 602-4 are vertically stacked with an external memory 612 in the 3D arrangement. Thus, the first pair of cluster chiplets 602-1 and 602-2 and the second pair of cluster chiplets 602-3 and 602-4 are disjointed, i.e., do not share any common cluster chiplet. The external memory 612 is interconnected with the cluster chiplets 602-3 and 602-4 using the plurality of TSVs and micro-bumps 610. The cache chiplet 608 is communicatively coupled with the system bus 604 of each of the cluster chiplets 602-1 and 602-2 and the external memory 612 is communicatively coupled with the system bus 604 of each of the cluster chiplets 602-3 and 602-4. This enables efficient, low latency data transfer and contributes to the overall performance and scalability of the integrated circuit 200 relative to other integrated circuits with current architecture, for example, as described in FIG. 1.

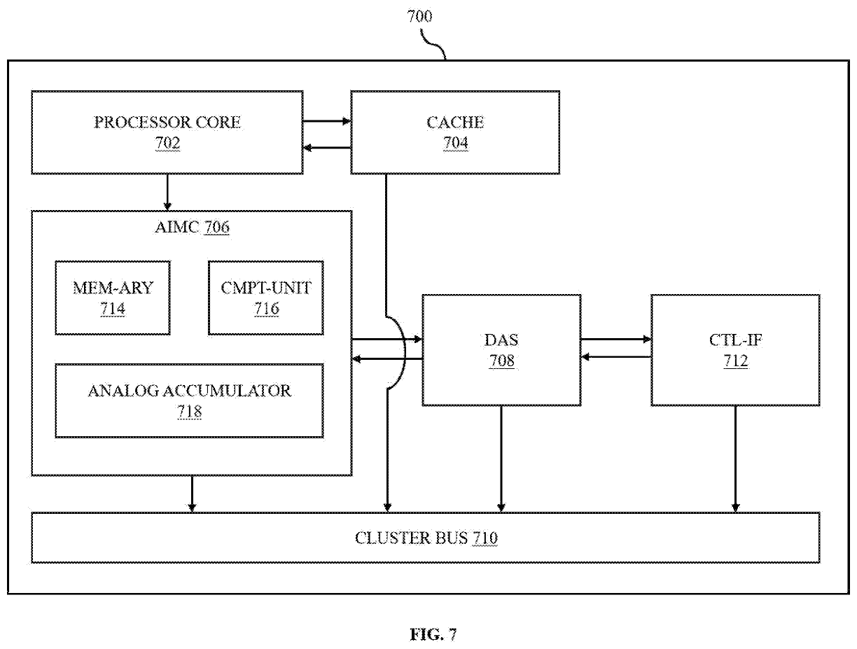

FIG. 7 is a simplified block diagram illustrating a tile 700 within the cluster chiplet 202 of the integrated circuit 200 according to various embodiments of the present disclosure. The tile 700 is same as the tile 206 within the cluster chiplet 202 of the integrated circuit 200. In accordance with the various embodiments of the present disclosure, each of the tile 700 within the cluster chiplet 202 comprises at least one processor core 702 coupled to a cache 704, an analog in-memory compute (AIMC) device 706, a digital access subsystem (DAS) 708 coupled to the AIMC device 706, and a cluster bus 710. The AIMC device 706 is operatively coupled to the at least one processor core 702 (hereinafter interchangeably referred to as “processor core” in singular for brevity) through a control interface (CTL-IF) 712. The cluster bus 710 is coupled to the processor core 702 through the cache 704 and the DAS 708, and to the system bus 204 of the cluster chiplet 202 (not shown in the figure).

In accordance with the embodiments of the present invention, the processor core 702 can be a general-purpose processor or a specialized processor based on the application of the integrated circuit 200. As such, the processor core 702 is capable of working with different types of AI models such as vision, LLMs, and generative models. Examples of the processor core 702 include, but not limited to, NPU, RISC-V CPU, and VECT GPU. In one embodiment and referring to FIG. 2, each of the tiles 206 can include one processor core 702. In one embodiment, each of the tile 206 can include plurality of processor cores 702 based on the application of the integrated circuit 200. In one example of such embodiment, the processor core 702 within each tile 206 can process data independently of each other. In one example of such embodiment, the processor core 702 within each tile 206 can process data simultaneously in parallel to optimize processing efficiency and high throughput for complex applications.

In accordance with the embodiments of the present invention, the processor core 702 is coupled to the cache 704 within the tile 700. The cache 704 can be a small, high-speed memory for storing frequently accessed data and instructions and can be located in close proximity to the processor core 702. Referring to FIG. 2, the location of the cache 704 within the tile 206 enables the processor core 702 to retrieve data from the cache 704 at a higher speed when compared to a slower main memory. This leads to reduced latency and optimized power efficiency as the need for power-intensive memory access is reduced.

In accordance with the embodiments of the present invention, the AIMC device 706 comprises a memory array (MEM-ARY) 714, a compute unit (CMPT-UNIT) 716, and an analog accumulator 718. The memory array 714 is configured to store input operands from an external digital system (not shown in the figure) coupled to the integrated circuit 200. The input operands are encoded as one of voltage levels and current levels. The compute unit 716 is configured to perform a plurality of multiply-accumulate operations in parallel on the input operands. The analog accumulator 718 is configured to accumulate computation results based on at least one of charge accumulation responsive to pulse signals and current accumulation.

Thus, referring to FIG. 2, the AIMC device 706 with analog computation and in-memory architecture within each tile 206 is faster than DIMC when processing tasks that are highly parallel or involve large datasets. This leads to higher and efficient data processing, reduced latency, and reduced power consumption as data is not transferred across multiple and distinct memory units and processors. Additionally, the AIMC device 706 with analog computation and in-memory architecture within each tile 206 leads to optimized area usage within each tile 206. In an example, the area occupied by the AIMC device 706 within each tile 206 is 1.3-1.4 times compared to SRAM memory cell within each tile 206. In an example, the AIMC device 706 can be designed to handle specific tasks such as matrix multiplications, vector operations, and neural network inference that can directly interface with the memory array 714. The AIMC device 706 with analog computation and in-memory architecture thus enables the integrated circuit 200 to be used for applications within ultra-low-power edge devices and high-performance autonomous systems.

In one embodiment of the present invention, the AIMC device 706 can be coupled to the external digital system (not shown in the figure) or an external data source (not shown in the figure) through the DAS 708. Examples of the DAS 708 include, but are not limited to, digital interfaces, digital converters, and digital controller that enable conversion of data from analog to digital and digital to analog and transfer of data between the AIMC device 706 (i.e., an analog computing unit) and the external data source or digital subsystem (i.e., a digital computing unit). The DAS 708 facilitates the bidirectional communication between the AIMC device 706 processing analog data and the external digital system or data sources processing digital data. This results in seamless communication between the AIMC device 706 and the external data source or digital subsystem, leading to efficient data flow and control across both analog and digital domains. Additionally, the integration of the AIMC device 706 with the DAS 708 enables enhanced hybrid computing capabilities, wherein the AIMC device 706 can leverage low-power, high-efficiency computation for specific tasks, while the DAS 708 ensures the results are correctly interpreted, stored, and further processed based on the application of the integrated circuit 200.

In accordance with the embodiments of the present invention, the control interface 712 is configured to program and configure at least one of the DAS 708 and the AIMC device 706. The control interface 712 may include configuration registers, programmable parameters, and control logic to adjust operating modes, data paths, and computational parameters of the DAS 708 and AIMC device 706 based on operational parameters of the application such performance, latency, resource utilization, and power consumption. Examples of the control interface 712 include, but are not limited to, high-bandwidth data buses, control lines, and synchronization mechanisms. In an example, the processor core 702 is configured to perform general purpose task and the AIMC device 706 is optimized to perform specialized task for AI based application by the control interface 712.

In accordance with the embodiments of the present invention, the cluster bus 710 supports high-speed, low-latency data transmission among the various components within the tile 700. The cluster bus 710 can be multidirectional and can include multiple data lines to handle parallel communication, enabling the simultaneous transfer of multiple data streams for greater throughput. The cluster bus 710 can be configured to optimize energy efficiency and performance within each of the tiles and within the overall cluster chiplet 202.

Thus, referring to FIG. 2 and FIG. 7, each of the cluster chiplet 202 comprises multiple clusters of computing units, i.e., the plurality of tiles 206, with each tile 206 comprising the processor core 702, the cache 704, the AIMC device 706, the DAS 708, and the cluster bus 710. These multiple clusters of computing units are designed to perform specialized computational tasks, enabling high-performance processing. The integration of such clusters of computing units allows for scalable and modular design of the integrated circuit 200 such that each cluster of computing units within the cluster chiplet 202 can function independently or in coordination with others to handle complex workloads efficiently.

Further, the vertical stacking of the components of the integrated circuit 200 in 3D arrangement enhances power efficiency, reduces data movement overheads, and optimizes PPA scaling to meet the ever-increasing demands of modern AI applications. For example, referring to FIG. 2, the vertical stacking of the cluster chiplets 202 creates a highly compact and dense architecture, allowing for more efficient use of physical space, thereby enabling the integrated circuit 200 to achieve high computational throughput while maintaining a smaller form factor. Additionally, the vertical stacking of the cluster chiplets 202 in the integrated circuit 200 facilitates scalability of the integrated circuit 200 in terms of both computational power and memory capacity without significantly increasing the physical footprint of the integrated circuit 200.

Further, referring to FIG. 7, the data throughput and energy efficiency is higher in the AIMC device 706 with vertical stacking as the data is directly fed into the AIMC device 706. Similarly, referring to FIG. 2 and FIG. 7, the data stored within the cache chiplet 208 can be used to accelerate the execution of tasks performed by the processor core 702 and the AIMC device 706 in the cluster chiplets 202. This significantly reduces the time required to access data from lower levels of the memory hierarchy. Additionally, the placement of the cache chiplet 208 between the pair of adjacent chiplets 202-1 and 202-2 in the vertical stacking can provide enhanced power distribution across the stacked configuration, ensuring balanced and efficient operation of the integrated circuit. In addition, referring to FIG. 6, the vertical stacking of the external memory 612 enables direct vertical integration of additional memory components leading to improved scalability of the integrated circuit 200.

Further, the vertical stacking of components reduces overall size and area of the integrated circuit 200 and improves memory density and latency of the integrated circuit 200, relative to other integrated circuits with current architecture, for example, as described in FIG. 1. Additionally, scalability in the vertical stacking increases by enabling the integration of more cluster chiplets without requiring a corresponding increase in the horizontal footprint of the integrated circuit 200. This allows for modular expansion of the integrated circuit 200 based on the application where space constraints or form factor limitations are critical considerations. In addition, the use of memory module having a higher storage density per unit area than SRAM as the cache chiplet reduces the overall size and area usage of the integrated circuit 200.

Further, the vertical stacking supports thermal management in the integrated circuit 200 allowing for better heat dissipation across the stacked cluster chiplets 202. Referring to FIG. 2, the cache chiplet 208 can act as a heat dissipation layer for the cluster chiplets 202-1 and 202-2, arranged above and below the cache chiplet 208, respectively. This arrangement leads to overall stability and performance optimization by allowing effective thermal solutions while scaling the integrated circuit 200 relative to other integrated circuits with current architecture, for example, as described in FIG. 1. The cache chiplet 208 located between the cluster chiplets 202-1 and 202-2 can provide enhanced power distribution across the stacked configuration, ensuring balanced and efficient operation of the entire integrated circuit 200.

Further, the plurality of TSVs and micro-bumps 210 connecting the cluster chiplets 202 in the vertical stacking supports high bandwidth communication and efficient data transfer between the cluster chiplets 202 with low interference. This enables the integrated circuit 200 to scale in performance by adding additional cluster chiplets 202 without compromising data transfer speed and overall efficiency relative to other integrated circuits with current architecture, for example, as described in FIG. 1. In addition, referring to FIG. 2 and FIG. 6, the cache chiplet 208 and the external memory 612 can be vertically stacked without increasing horizontal footprint of the integrated circuit 200 as the need for placing external memory separately horizontally on the integrated circuit 200 is eliminated. This increases the scalability of the integrated circuit 200 and provides for a compact design.

Therefore, the present disclosure enables the integrated circuit 200 to achieve enhanced performance, reduced power consumption, and minimized physical area usage while scaling effectively for larger and more complex AI workloads. The integrated circuit 200 in accordance with various embodiments of the present disclosure can be manufactured using various known techniques. In an example, the vertical stacking of the components in the integrated circuit 200 is initiated by placing a first cluster chiplet 202-1 on top of a substrate (not show in the figure), then placing remaining components such as the cache chiplet 208 and the second cluster chiplet 202-2 in accordance with the various embodiments, bonding the different components, and packing all the components to form the integrated circuit 200. In an example, the vertical stacking of the components in the integrated circuit 200 may include placing intermediate layers such as bonding layers and other electrical components such as transistors, resistors, capacitor, etc., to establish electrical connectivity among the various components in accordance with the various embodiments of the present disclosure. In the example shown in the figures, the TSVs and the micro-bumps 210 are represented only in the gaps between the dies for the sake of clarity but may extend through the components. In some examples, different TSVs and the micro-bumps may extend through different components. The bidirectional arrows indicate a two-way communication between the components of the integrated circuit 200. Although the examples shown in the figures, i.e., FIG. 2, FIG. 3, FIG. 4, FIG. 5, FIG. 6, and FIG. 7 only illustrate two or four cluster chiplets 202, the integrated circuit 200 may include more than four cluster chiplets.

The present disclosure has been described in terms of specific embodiments, but it is to be understood that the scope of the disclosure is not limited to the particular systems or methods described. It should be recognized that those skilled in the art may make modifications and improvements without departing from the broader inventive concepts disclosed herein. Such modifications and improvements are intended to be included within the scope of the disclosure.

It is also to be understood that the terminology used herein is for the purpose of describing particular embodiments only and is not intended to be limiting. The scope of the disclosure is defined by the claims appended hereto, and all equivalents thereof, as would be understood by those skilled in the art.

Although the present disclosure has been described in languages specific to structural features and/or methodological acts, it is to be understood that the present disclosure defined in the appended claims is not necessarily limited to the specific features or acts described above. Rather, the specific features and acts described above are disclosed as example forms of implementing the claims.

We claim:

1. An integrated circuit comprising:
a plurality of cluster chiplets vertically stacked, each of the cluster chiplets comprising:
a plurality of tiles laterally arranged, each of the tiles comprising:
at least one processor core coupled to a cache,
an analog in-memory compute (AIMC) device operatively coupled to the at least one processor core,
a digital access subsystem coupled to the AIMC device; and
a cluster bus coupled to the digital access subsystem; and
a system bus coupled to the cluster bus of each of the tiles; and
at least one cache chiplet vertically stacked with the plurality of cluster chiplets, wherein the at least one cache chiplet is arranged between a pair of adjacent cluster chiplets from the plurality of cluster chiplets.

2. The integrated circuit as claimed in claim 1, wherein each of the plurality of tiles further comprises a control interface coupled to the digital access subsystem, wherein the control interface is configured to at least one of the digital access subsystem and the AIMC device.

3. The integrated circuit as claimed in claim 1, wherein the digital access subsystem is configured to enable bidirectional communication between the AIMC device and an external digital system.

4. The integrated circuit as claimed in claim 1, wherein the AIMC device comprises:
a memory array configured to store input operands from an external digital system coupled to the integrated circuit;
a compute unit configured to perform a plurality of multiply-accumulate operations in parallel on input operands stored in the memory array; and
an analog accumulator configured to accumulate computation results based on at least one of charge accumulation responsive to pulse signals and current accumulation, wherein the input operands from the external digital system are encoded as one of voltage levels and current levels.

5. The integrated circuit as claimed in claim 1, wherein the at least one cache chiplet and the pair of adjacent cluster chiplets are interconnected using a plurality of through-silicon vias and micro-bumps.

6. The integrated circuit as claimed in claim 5, wherein the at least one cache chiplet is coupled to the system bus of each of the pair of adjacent cluster chiplets.

7. The integrated circuit as claimed in claim 5, wherein the at least one cache chiplet comprises:
a plurality of cache banks accessible by the pair of adjacent cluster chiplets; and
an arbiter configured to manage access requests from the pair of adjacent cluster chiplets.

8. The integrated circuit as claimed in claim 1, further comprising at least one external memory vertically stacked with the plurality of cluster chiplets, wherein the at least one external memory is arranged between a pair of adjacent cluster chiplets from the plurality of cluster chiplets.

9. The integrated circuit as claimed in claim 8, wherein the at least one external memory and the pair of adjacent cluster chiplets are interconnected using a plurality of through-silicon vias and micro-bumps.

10. The integrated circuit as claimed in claim 8, wherein the at least one external memory is coupled to the system bus of each of the pair of adjacent cluster chiplets.

11. The integrated circuit as claimed in claim 8, wherein each of the pair of adjacent cluster chiplets comprises a memory controller coupled to the system bus and the at least one external memory.
